(19) United States
(12) Patent Application Publication
(10) Pub. No.: US 2007/0062326 A1
(43) Pub. Date: Mar. 22, 2007

(54) Double mount handguard

(76) Inventors: Kenneth T. Laivins, Hebron, OH (US); Glen A. Laivins, Hebron, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/229,362

(22) Filed: Sep. 16, 2005

(51) Int. Cl. B62K 21/12

(52) U.S. Cl. 74/551.8

(57) ABSTRACT

A handguard for a handlebar is disclosed herein. In one embodiment, the handguard includes a shield and a plurality of mounting devices configured to secure the shield to the handlebar. Each mounting device is positioned at least a minimum distance from an end of a handlebar, such that an end of the handlebar is free. The shield is connected to the mounting devices so that it positioned in front of the handlebar.

### FIELD OF INVENTION

The present application relates to a handguard for a handlebar. In particular, the present application relates to a double mount handguard for a handlebar of a vehicle, such as a bicycle, motorcycle, motor scooter, motorbike, or all-terrain vehicle (“ATV”).

### BACKGROUND

Handguards for protecting the hands of riders of bicycles, motorcycles, motor scooters, motorbikes, and ATVs are known in the art. The handguard is configured to protect a rider's hands from wind, rain, and debris. In one known embodiment, the handguard is configured to be mounted on a handlebar such that the handguard contacts an end of the handlebar and another portion of the handlebar.

### BRIEF DESCRIPTION OF THE DRAWINGS

In the accompanying drawings, structures are illustrated that, together with the detailed description provided below, describe exemplary embodiments of the claimed invention.

In the drawings and description that follows, like elements are identified with the same reference numerals. The drawings are not to scale and the proportion of certain elements may be exaggerated for the purpose of illustration.

FIG. 1 is a simplified perspective view of one embodiment of a handguard 100 disposed on a motorcycle M;

FIG. 2 is a simplified front perspective view of one embodiment of a handguard 100 attached to a handlebar H;

FIG. 3 is an exploded back perspective view of one embodiment of a handguard 100;

FIG. 4 is a simplified side plan view of one embodiment of a mounting bracket 120.

FIG. 5 is a simplified top plan view of one embodiment of a handguard 100 attached to a handlebar H;

FIG. 6 is a simplified front perspective view of another embodiment of a handguard 200 having a rubber lining 220; and

FIG. 7 is a simplified top plan view of another embodiment of a handguard 300 attached to a handlebar H.

### DETAILED DESCRIPTION

The present application is directed to a double mount handguard for a handlebar of a vehicle, such as a motorcycle, a motorbike, a motor scooter, a bicycle, or an ATV. The handguard may be employed to protect a rider's hand from wind, rain, and debris.

An “inner” direction as used herein refers to a direction towards the body of the vehicle.

An “outer” direction as used herein refers to a direction away from the body of the vehicle.

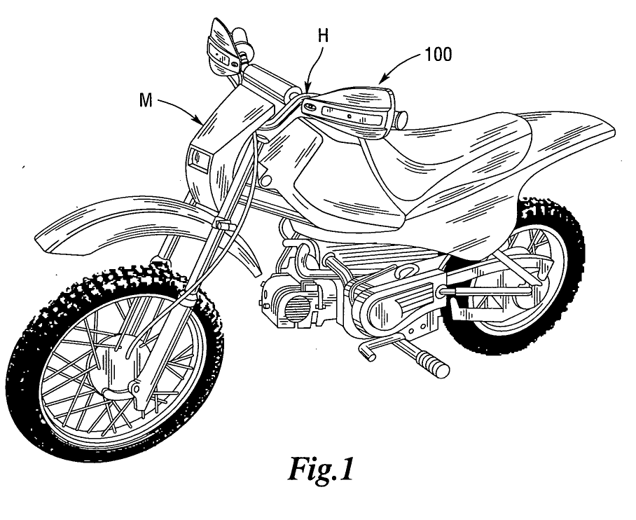

FIG. 1 illustrates a simplified perspective view of one embodiment of a handguard 100 mounted on a handlebar H of a motorcycle M. In this embodiment, the handguard 100 is positioned in front of the handlebar H to protect a rider's hand. In alternative embodiments, the handguard 100 may be employed on a motorbike, motor scooter, bicycle, ATV, or any other vehicle having handlebars.

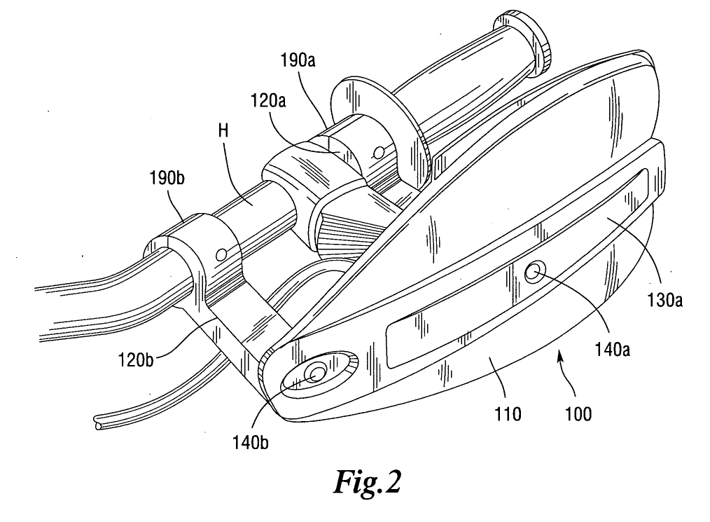

FIG. 2 illustrates a simplified front perspective view of one embodiment of a handguard 100 attached to a handlebar H. The handguard 100 includes a shield 110, an outer mounting bracket 120a that connects to the handlebar H, and an inner mounting bracket 120b that connects to the handlebar H such that the inner mounting bracket 120b is closer to the body of the vehicle than the outer mounting bracket 120a. In an alternative embodiment (not shown), the handguard 100 includes a shield 110 and three or more mounting devices.

The shield 110 may be constructed of a variety of polymeric materials, including, without limitation, polypropylene, polyethylene, ethylene propylene diene monomer (EPDM) rubber, or a combination thereof. Polypropylene provides stiffness to the shield 110, while polyethylene provides resilience and EPDM rubber provides flexibility.

Since the shield 110 is constructed of a polymeric material, it can be molded to include complex features and to facilitate installation on a handlebar H. Furthermore, a polymeric material can flex to the shape of a handlebar H, allowing the shield 110 to be attached to handlebars of different shapes and sizes. Additionally, the use of a polymeric material allows the shield 110 to absorb impacts and retain its shape.

In one embodiment, the mounting brackets 120a,b are constructed of metal. In another embodiment, the mounting brackets 120a,b are constructed of a polymeric material. The polymeric material of the mounting brackets 120a,b may be different from the polymeric material of the shield 110, to provide for different levels of strength.

With continued reference to FIG. 2, the shield 110 has a concave shape configured to protect a rider's hand in multiple directions. In one embodiment, a front face of the shield 110 includes a recess configured to receive a front support member 130a. In an alternative embodiment (not shown), the shield 110 does not have a front support member.

For safety reasons, the front support member 130a is recessed in the shield 110 such that none of its edges are exposed. In the one embodiment, the support member 130a is constructed of metal. In alternative embodiments, the support member is constructed of a polymeric material. The polymeric material may be different from that of the shield 110, to provide different levels of strength.

As will be explained in further detail below, in one embodiment the front support member 130a has two apertures 140a,b, while the shield 110 has two corresponding apertures (not shown), such that the support member 130a may be attached to the shield 110 via fasteners (not shown). In alternative embodiments (not shown), the support member and shield each have a single aperture or the support member and shield each have three or more apertures.

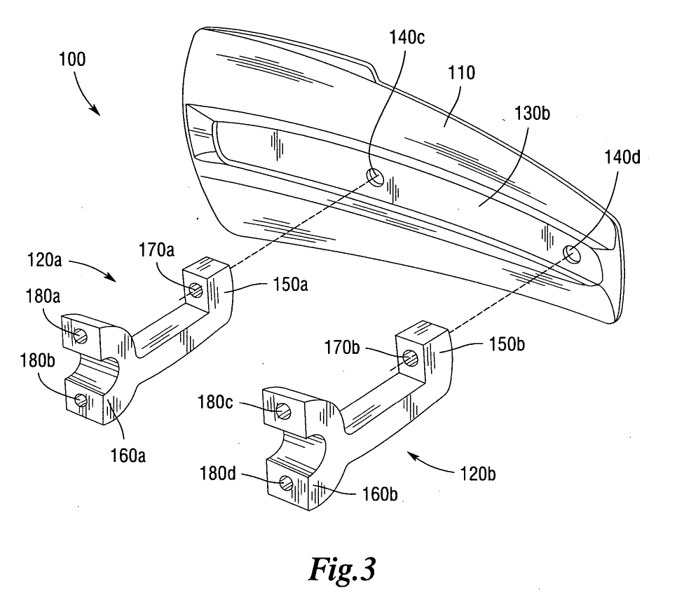

FIG. 3 illustrates an exploded back perspective view of one embodiment of a handguard 100. In this embodiment, the mounting brackets 120a,b are elongated members having mounting flanges 150a,b at a front end, and C-shaped portions 160a,b at a back end. The mounting flange 150a,b of each mounting bracket 120a,b includes an aperture 170a,b configured to receive a fastener (not shown) to connect each mounting bracket 120a,b to the shield 110. Exemplary fasteners include, without limitation, screws, bolts, ties, or any other appropriate fastening devices. In other embodiments (not shown) the mounting flange 150a,b of each mounting bracket 120a,b includes two or more apertures (not shown).

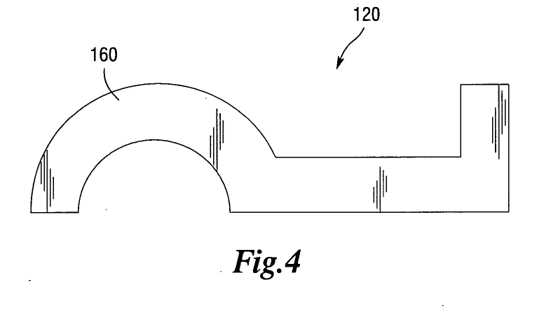

In FIG. 3, the C-shaped portions 160a,b of each mounting bracket 120a,b are disposed in an upright configuration. In an alternative embodiment illustrated in FIG. 3, the C-shaped portion 160 of a mounting bracket 120 is disposed horizontally (as shown in FIG. 4). In other alternative embodiments (not shown), the C-shaped portion of a mounting bracket may be disposed in any orientation.

Referring back to FIG. 3, in this embodiment, the C-shaped portion 160a,b of each mounting bracket 120a,b has a pair of apertures 180a,b,c,d configured to receive fasteners (not shown) to connect each mounting bracket 120a,b to a C-shaped bracket 190a,b (as shown in FIG. 2). Exemplary fasteners include, without limitation, screws, bolts, ties, or any other appropriate fastening devices. The C-shaped bracket 190a,b and the C-shaped portion 160a,b of each mounting bracket 120a,b are joined by fasteners to create a friction fit around a handlebar H. In another embodiment (not shown) the back end 160a,b of each mounting bracket 120a,b includes three or more apertures (not shown). In yet another embodiment (not shown), the mounting bracket is a unitary mounting bracket. For example, the back end of each mounting bracket 120a,b may be an adjustable clamp that connects to the handlebar H.

With continued reference to FIG. 3, the shield 110 includes a recess in its back face configured to receive a back support member 130b. In an alternative embodiment (not shown), the shield does not include a back support member. In another alternative embodiment (not shown), the shield includes neither a front support member nor a back support member.

For safety reasons, the back support member 130b is recessed in the shield 110 such that none of its edges are exposed. In one embodiment, the support member 130b is constructed of metal. In alternative embodiments, the support member is constructed of a polymeric material. The polymeric material may be different from that of the shield 110, to provide different levels of strength.

In FIG. 3, the back support member 130b includes two apertures 140c,d, which correspond to two apertures (not shown) in the shield 110, and two apertures 140a,b in the front support member 130a. A fastener (not shown) is passed through the apertures 140a,b of the front support member 130a (see FIG. 2), the corresponding apertures (not shown) of the shield 110, the apertures 140c,d of the back support member 130b, and the apertures 170a,b of the front ends 150a,b of the mounting brackets 120a,b, thereby fixing the front and back support members 130a,b in the front and back recesses of the shield 110, and connecting the shield 110 to the mounting brackets 120a,b.

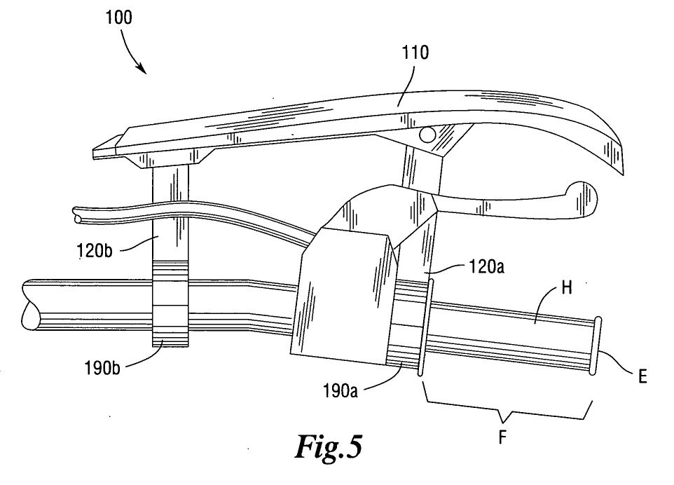

FIG. 5 illustrates a simplified top view of the handguard 100 connected to a handlebar H having an outer end E. In the illustrated embodiment, the outer bracket 120a is connected to the handlebar H at a minimum distance from the outer end E. In one embodiment, the outer mounting bracket 120a is connected to the handlebar H at a location five to eight inches from the outer end E. In another embodiment, the outer mounting bracket 120a is connected to the handlebar H at a position at least 7 inches from the outer end E.

The portion of the handlebar H from the outer bracket 120a to the outer end E constitutes a free end F. The free end F does not directly contact any component of the handguard 100. The length of the free end F is equal to the distance between the outer mounting bracket 120a and the outer end E. By providing a free end F, a rider is able to quickly remove his hand from the handlebar H, if necessary.

In one embodiment, the shield 110 is positioned at a distance that allows a rider to quickly remove his hand from the handlebar H, but close enough to maximize protection of the rider's hands from wind, rain, and debris. In one embodiment, the outer mounting bracket 120a is four to six inches long and the inner mounting bracket 120b is two to four inches long. In another embodiment, the outer mounting bracket 120a is five inches long and the inner mounting bracket 120b is three inches long.

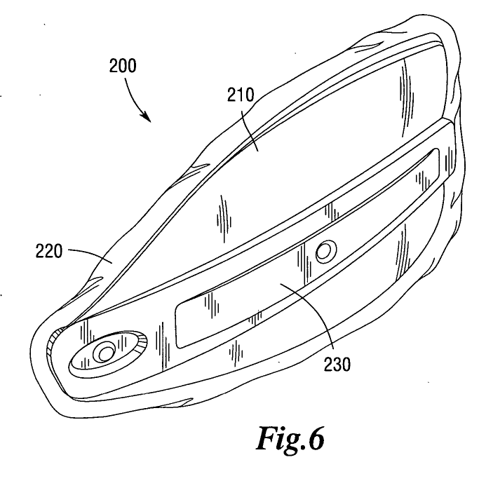

FIG. 6 illustrates a front perspective view of another embodiment of a handguard 200. In this embodiment, the handguard includes a shield 210 having a rubber lining 220 configured to surround the perimeter of the shield 210 to protect a rider from injury in case of an accident and to protect the shield from damage. In an alternative embodiment (not shown), the rubber lining 220 only covers a portion of the exposed edges of the shield portion 110. In another alternative embodiment (not shown), the rubber lining 220 is removable.

With continued reference to FIG. 6, the handguard 200 further includes a front support member 230, a back support member (not shown) and mounting brackets (not shown), as disclosed above in relation to FIGS. 1,2, and 4. In alternative embodiments (not shown), the handguard 200 includes only a front support member, only a back support member, or neither a front support member nor a back support member.

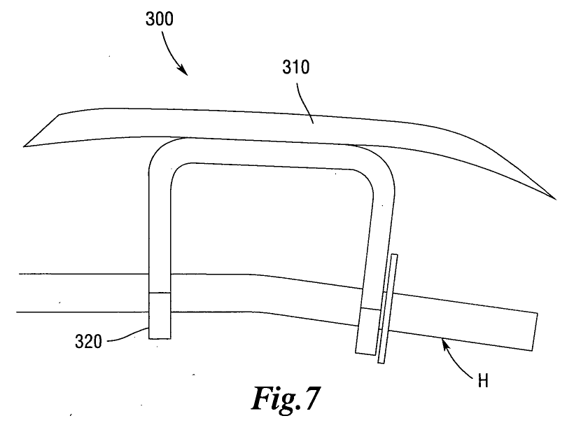

FIG. 7 illustrates a simplified top view of another alternative embodiment of a handguard 300. In the illustrated embodiment, the handguard 300 includes a shield 310 and a single mounting bracket 320 that connects to a handlebar H at two locations. In one embodiment, the mounting bracket 320 is substantially U-shaped. In alternative embodiments, the mounting bracket is I-shaped or is configured to attach to a handlebar at three or more locations.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

1. A handguard for a handlebar, the handguard comprising:
a shield;
a plurality of mounting devices, configured to secure the shield to the handlebar, each mounting device is positioned at least a minimum distance from an end of a handlebar, such that the shield is positioned in front of the handlebar.

2. The handguard of claim 1, wherein the minimum distance is at least five inches from the end of the handlebar.

3. The handguard of claim 1, wherein the shield includes at least one support member.

4. The handguard of claim 3, wherein the at least one support member includes a first metal member disposed on a front face of the shield and a second metal member disposed on a back face of the shield.

5. The handguard of claim 4, wherein the shield includes recesses in the front and back faces for receiving the first and second metal bars, such that the edges of the first and second metal bars are unexposed.

6. The handguard of claim 4, wherein the plurality of mounting devices are configured to be attached to the second metal member.

7. The handguard of claim 1, wherein the shield is constructed of a polymeric material.

8. The handguard of claim 1, wherein the shield includes a rubber lining disposed on at least one edge of the shield.

9. The handguard of claim 1, wherein the plurality of mounting devices are constructed of metal.

10. The handguard of claim 1, wherein each of the plurality of mounting devices includes a C-shaped bracket.

11. A handguard kit for a handguard configured to be attached to a handlebar of a vehicle such that the handlebar has a free end, the handguard kit comprising:
a hand shield; and
at least one bracket, wherein the at least one bracket is configured to be connected to the shield and to be connected to the handlebar at a plurality of locations.

12. The handguard kit of claim 11, wherein each of the plurality of locations on the handlebar is spaced at least five inches from the end of the handlebar.

13. The handguard kit of claim 11, wherein the at least one bracket includes a plurality of brackets, each bracket having a front end configured to be connected to the shield and a back end configured to be attached to the handlebar.

14. The handguard kit of claim 11, further comprising at least one support member.

15. The handguard kit of claim 14, wherein the at least one support member includes a first member attached to a front side of the hand shield and a second member disposed between a back side of the shield and the plurality of brackets.

16. The handguard of claim 11, wherein the handguard further includes a rubber lining disposed on at least one edge of the shield.

17. The handguard of claim 11, wherein the hand shield is constructed of a polymeric material.

18. The handguard of claim 11, wherein the plurality of brackets are constructed of metal.

19. A mounting bracket configured to be connected to a hand shield for a handlebar of a vehicle, the mounting bracket comprising:
an elongated member having a mounting flange on a front end and a back end that is generally C-shaped, both ends being configured to receive fasteners; and
a C-shaped member configured to be connected to the back end of the elongated member by at least one fastener.

20. The mounting bracket of claim 19, wherein the front end of the elongated member is configured to be connected to a support member of a hand shield.

21. The mounting bracket of claim 19, wherein the elongated member and the C-shaped member are both constructed of metal.
